(19) United States
(12) Patent Application Publication
(10) Pub. No.: US 2026/0208346 A1
(43) Pub. Date: Jul. 23, 2026

(54) ROBOT SYSTEM

(71) Applicant: Krystian Dylewski, Warszawa (PL)

(72) Inventor: Krystian Dylewski, Warszawa (PL)

(21) Appl. No.: 19/142,630

(22) PCT Filed: Nov. 9, 2023
(86) PCT No.: PCT/IB2023/061314

§ 371 Date: Jun. 23, 2025

(30) Foreign Application Priority Data
Dec. 22, 2022 (PL) P.443251

(51) Int. Cl. B25J 9/00; B25J 5/00; B25J 9/10

(52) U.S. Cl. CPC B25J 9/0003; B25J 5/00; B25J 9/106

(57) ABSTRACT

The robot system comprises a supporting structure on a mobile base and a control system with a power source, wherein at least one manipulator arm is slidably attached to the supporting structure, and the supporting structure comprises a first supporting column and a second supporting column rotatably connected to the mobile base via base joints with one degree of freedom. One manipulator arm is slidably attached to each supporting column. The manipulator arm includes a first support, a second support, a boom and a support element. The boom comprises a first boom part and a second boom part, wherein a first end of the first boom part is connected to the first support via a first joint with one degree of freedom, and a second end of the first boom part is slidably connected to the second boom part and is rotatably connected to the first end of the support element via the second joint. The second end of the support element is connected to the second support via a third joint with one degree of freedom, and a distal end of the second boom part ends with a gripper, wherein the robot system further comprises a monitoring system.

### TECHNICAL FIELD

The subject of the invention is a robot system designed to programmably perform manipulation activities, especially in consumer applications, such as picking and placing goods from and to a warehouse, operating cash registers, cleaning, and cooking.

### BACKGROUND ART

Many designs of robot systems with robot arms and manipulators are known, especially in industrial applications such as production automation. Currently, however, solutions used in industrial robotics have not been adopted in consumer applications, mainly due to the high price of such solutions. The structures of industrial robots must be adapted to appropriate loads, speed of operation, reliability and, in particular, precision. On the other hand, the space they occupy and move in is usually adapted to them and is usually of little importance. In consumer applications, the opposite is true. They can have much lower requirements for these parameters, for example speed or precision, and still provide value, but they must work in spaces similar to those in which humans move and be very flexible in this respect to remain universal. Additionally, the use of solutions known from industrial robotics, which meet the criteria of flexibility of the space in which they work, using cheaper and worse equivalents, so that the entire structure meets the price criteria, leads to the fact that such arms are able to lift very small masses, occupy too much space or are not flexible enough.

From the European patent application EP2309357A1, a method and a robotic device for moving elongated elements, for example sausages, to or from a storage system are known. However, the presented solution is not suitable for moving elements with shapes other than elongated products. European patent application EP3782935A1 discloses a robotic service and manipulation device that is adapted to move within a warehouse grid to service warehouse equipment. The mentioned device comprises a docking mechanism for storage devices requiring servicing. work in environments similar to those in which people move. Canadian patent application No. CA2635135A1 discloses a medical robot system including a base and a manipulator arm including a gripper for holding and moving medical instruments. The presented solution is expensive and complicated due to joints with many degrees of freedom. Due to the low mass of the moved medical instruments, the mentioned robot system is not adapted to move elements with a mass much higher than standard medical instruments.

### Technical Problem

The presented robot systems are highly specialized systems for specific applications and are not intended for universal use. In turn, humanoid robots for universal applications, known from many sources, are very complicated and expensive, which is also due to the requirements to ensure high precision of movements and positioning, which are not required in consumer applications.

### Solution to Problem

Therefore, the purpose of the invention is to provide a robot system which, through the use of generally available components and simple solutions, e.g. some joints with one degree of freedom instead of many, is relatively cheap and easy to produce, and at the same time enables the implementation of tasks, in particular the movement of various products with dimensions in a wide range. Moreover, thanks to use of the support element that is not present in the prior art systems presented, the robot system according to the invention is adapted to move objects with a much greater mass compared to the prior art systems presented.

The essence of the invention is a robot system containing a supporting structure on a mobile base and a control system with a power source Z. The mobile base comprises any drivable means, such as wheels, caterpillar tracks, etc. At least one manipulator arm 4 is slidably attached to the supporting structure.

### SUMMARY OF INVENTION

The robot system according to the invention is characterized in that the supporting structure 2 includes a first supporting column 5a and a second supporting column 5b, each rotatably attached to the mobile base 3 via base joints 31a, 31b with one degree of freedom. One manipulator arm is slidably attached to each supporting column via the supporting column guides. The manipulator arm comprises a first support, a second support, a boom and a support element. The first and second supports can be moved along the guides of the supporting column. The movement of the first and second supports along the guides of the supporting column can be accomplished by a rack system located on the guide and a pinion gear located in the first and second supports, driven, for example, pneumatically, hydraulically or by an electric motor. The boom comprises a first boom part and a second boom part. A first end of the first boom part is connected to the first support via a first joint with one degree of freedom. A second end of the first boom part is slidably connected to the second boom part and rotatably connected to a first end of the support element via a second joint. The sliding movement of the second boom part relative to the first boom part can be realized by means of a linear actuator, the cylinder of which constitutes the first boom part, and the piston rod constitutes the second boom part. A second end of the support element is connected to the second support via a third joint with one degree of freedom, and a distal end of the second boom part ends with a gripper. The axis of rotation of the first joint and the third joint is perpendicular to the longitudinal axis defined by the supporting column guide. A gripper can be any type of manipulator enabling interaction with spatial objects of any dimensions, consisting of grabbing, moving and dropping objects. The robot system also comprises a monitoring system. The monitoring system enables visual identification of objects with which the gripper interacts and orientation in the working environment in which the robot system moves. The monitoring system may include at least one optical device, such as a camera, LIDAR, distance sensor, or others known in the art, located anywhere in the robot system, such as on the connector, on the boom, or on the mobile base. Preferably, the first supporting column and the second supporting column each comprise a first guide and a second guide. The first support is slidably mounted on the first guide, and the second support is slidably mounted on the second guide. This arrangement allows each support to move independently substantially along the entire length of the first and second guides. This configuration can be implemented using a second joint with at least two rotational degrees of freedom. Preferably, the mobile base comprises at least three running elements. Each running element comprises a linear actuator permanently attached to the mobile base on its proximal side to the supporting column or guide, and on the distal side of the linear actuator a bracket of the wheel or a wheel bracket or a wheel hub is permanently attached. This configuration allows to change the length of the running element, which is beneficial, for example, when maneuvering in tight warehouse spaces or in a situation where the robot system lifts objects with significantly different weights, in which case it is beneficial to change the arrangement of the points of contact between the robot system and the ground. The wheel bracket supports the wheel, for example via a bearing. The robot system can be driven using any wheel drive configuration, for example, two out of three wheels of the robot system can be driven. The wheels can be driven pneumatically, hydraulically or by electric motors. Preferably, the first supporting column and the second supporting column are rotatably connected in the part opposite to the mobile base by a connector, each via a fourth joint respectively. Connecting the ends of the supporting columns distal to the mobile base with a connector provides additional stiffness of the supporting structure, which increases the load-bearing capacity of the robot system. Preferably, the support element is an auxiliary linear actuator allowing the length of the support element to be changed. Changing the length of the support element allows to increase the working space of the robot system to adapt to the changing environment in which the robot system moves. The control system may comprise any device that executes commands in the form of a computer program, such as a microprocessor or microcontroller. The control system is designed to control the drive of the robot's wheels and the linear position of actuators or actuators in order to move the robot system to a given position in the work environment and to set the joints of the robot system in a configuration that allows interaction with the target spatial object. The control system is also responsible for communicating with the cameras of the robot system in order to obtain an image of the surroundings of the robot system, on the basis of which the control of the wheels and joints of the robot system is determined in order to achieve the desired goal, such as picking up goods from a warehouse shelf, moving the robot system with the goods or placing the transferred goods at a new destination. All electrically powered elements are electrically connected through the control system to the battery located, for example, in the mobile base.

### BRIEF DESCRIPTION OF DRAWINGS

The invention is described in more detail in an embodiment and in the drawing, in which:

FIG. 1 illustrates a schematic perspective view of the structure of the robot system,

FIG. 2 illustrates a schematic perspective view of an embodiment in which the first support is located on the first guide and the second support is located on the second guide,

FIG. 3 illustrates a schematic diagram of the control system,

FIG. 4 illustrates a perspective view of an embodiment of the invention.

### DESCRIPTION OF EMBODIMENTS

### Detailed Description Of The Figures

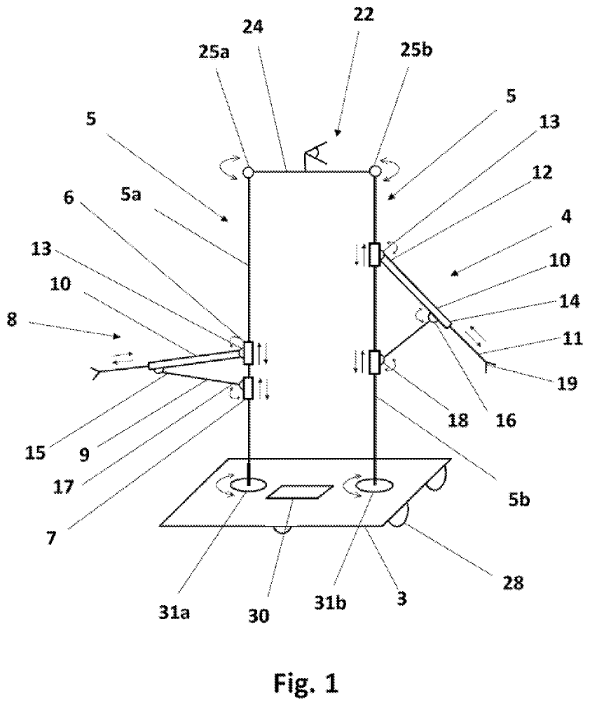

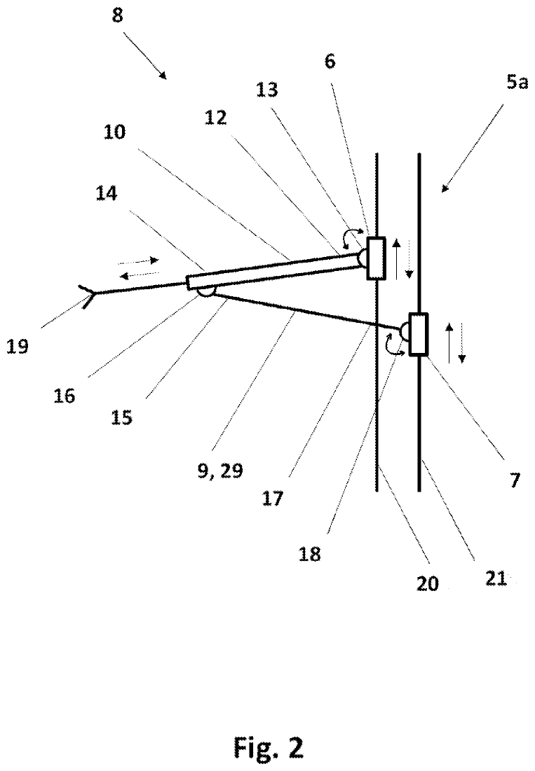

FIG. 1 and FIG. 2 schematically show the construction of the robot system according to the invention, including a support structure 2 located on a mobile base 3.

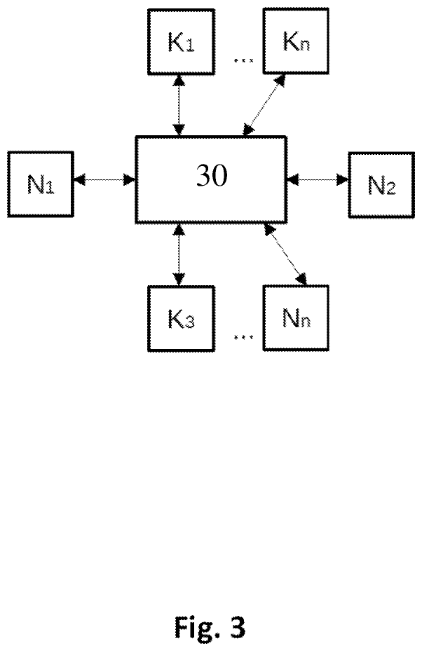

FIG. 3 schematically illustrates the control system 30 connected to the cameras K₁ and K₂ of the monitoring system 22 and with drives N₁, N₂, N₃ and Nₙ.

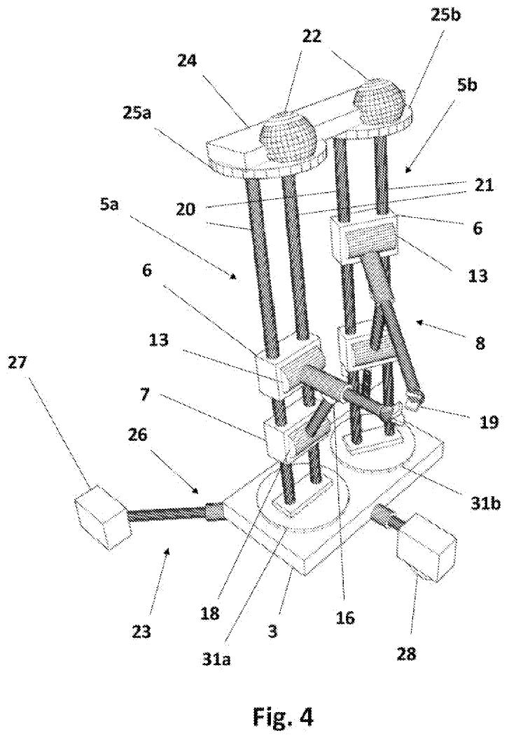

FIG. 4 illustrates an embodiment of the invention in the form of a robot system 1 comprising a supporting structure 2 on a mobile base 3 and a control system 30 with a power source Z in the form of a battery not shown in the drawing. The mobile base 3 comprises three running elements 23 each containing a wheel 28. Each supporting column 5a, 5b comprises a first guide 20 and a second guide 21, to which one manipulator arm 4 is each slidably attached. The first supporting column 5a comprising the first guide 20 and the second guide 21 is pivotally attached to the mobile base 3 by means of a joint 31a with one rotational degree of freedom. The second supporting column 5b comprising the first guide 20 and the second guide 21 is pivotally attached to the mobile base 3 by means of a joint 31b with one rotational degree of freedom. One manipulator arm 4 is attached slidably to each supporting column 5a, 5b via the supporting column guides 20, 21. The manipulator arm 4 comprises a first support 6, a second support 7, a boom 8 and a support element 9. The first and second supports 6, 7 in the activated state are moved along the guides of the supporting column 20, 21. The movement of the first and second supports 6, 7 along the guides of the supporting column 20, 21 is accomplished by a rack system located on the guide and a pinion gear located in the first and second supports 6, 7, driven by means of an electric motor. The boom 8 comprises a first boom part 10 and a second boom part 11. The first end 12 of the first boom part 10 is connected to the first support 6 via a first joint 13 with a single degree of freedom. The second end 14 of the first boom part 10 is slidably connected to the second boom part 11 and rotatably connected to the first end 15 of the support element 9 via the second joint 16. The sliding movement of the second boom part 11 relative to the first boom part 10 can be realized by means of a linear actuator, the cylinder of which constitutes the first boom part 10, and the piston rod constitutes the second boom part 11. The other end 17 of the support element is connected to the second support 7 via a third joint 18 with one degree of freedom, and the distal end of the second boom part 11 ends with a gripper 19. The axis of rotation of the first joint 13 and the third joint 18 is perpendicular to the longitudinal axis defined by the guide of the supporting column 5a, 5b. The gripper 19 may be any type of manipulator enabling interaction with spatial objects of any dimensions, consisting of grabbing, moving and dropping objects. The robot system 1 also comprises a monitoring system 22. The monitoring system 22 enables visual identification of objects with which the gripper 19 interacts and orientation in the working environment in which the robot system 1 moves. The monitoring system 22 comprises two cameras located on the connector 24. The first supporting column 5a and the second supporting column 5b each comprise a first guide 20 and a second guide 21. The first support 6 is slidably mounted on the first guide 20, and the second support 7 is slidably mounted on the second guide 21. This arrangement allows each support 6, 7 to move independently substantially along the entire length of the first and second guides 20, 21. This configuration is implemented by means of a second joint 16 with two rotational degrees of freedom. The mobile base 3 comprises running elements 23. Each running element 23 comprises a linear actuator 26 permanently attached to the mobile base 3 on the proximal side to the supporting column or guide, and on the distal side of the linear actuator 26 a bracket 27 of the wheel 26 is permanently attached. The bracket 27 of the wheel 26 supports the wheel, for example via a bearing. The drive of the robot system 1 is realized by means of two driven wheels 28 out of three wheels 28 of the robot system 1. The wheels 28 are driven by electric motors. The first supporting column 5a and the second supporting column 5b are rotatably connected in the part opposite to the mobile base 3 by a connector 24, each via a fourth joint 25a, 25b with a single rotational degree of freedom. The support element 9 is an auxiliary linear actuator 29 allowing the length of the support element 9 to be changed. The control system 30 comprises a computer program which, when executed by a microprocessor, controls the drive of the wheels 28 of the robot system 1, the linear position of the supports 6, 7, and the linear position of the booms and linear actuators in order to move the robot system 1 to a given position in the work environment and in order to set the robot system 1 in a configuration that allows interaction with the target spatial object. The control system 30 is also responsible for communicating with the monitoring system 22 of the robot system 1 in order to obtain an image of the surroundings of the robot system 1, on the basis of which the control of the wheels 28 and spatial configuration of the manipulator arm 4 of the robot system 1 is determined in order to achieve the desired goal, such as picking up goods from a warehouse shelf, moving the robot system with the goods or placing the transferred goods at a new destination.

1. A robot system including a supporting structure on a mobile base and a control system with a power source, wherein at least one manipulator arm is slidably attached to the supporting structure, characterized in that the supporting structure includes a first supporting column and a second supporting column rotatably attached to the mobile base via base joints with one degree of freedom, wherein to each supporting column one manipulator arm is slidably attached, wherein the manipulator arm comprises a first support, a second support, a boom and a support element, wherein the boom comprises a first boom part and a second boom part, wherein a first end of the first boom part is connected to the first support via a first joint with one degree of freedom, and a second end of the first boom part is slidably connected to the second boom part, and rotatably connected to a first end of the support element via a second joint wherein a second end of the support element is connected to the second support via a third joint with one degree of freedom, and a distal end of the second boom part is ended with a gripper, wherein the robot system also comprises a monitoring system.

2. The robot system according to claim 1, characterized in that the first supporting column and the second supporting column each contain a first guide and a second guide, the first support being slidably mounted on the first guide and the second support being slidably mounted on the second guide.

3. The robot system according to claim 1, characterized in that the mobile base comprises at least three running elements, wherein each running element comprises a linear actuator permanently attached on its proximal side to the mobile base, and on the distal side of the linear actuator a bracket of the wheel is permanently attached.

4. The robot system according to claim 1, characterized in that the first supporting column and the second supporting column are rotatably connected in the part opposite to the mobile base by a connector via the fourth joint respectively.

5. The robot system according to claim 1, characterized in that the support element is an auxiliary linear actuator enabling, the length of the support element to be changed.
